(19) United States
(12) Patent Application Publication
(10) Pub. No.: US 2005/0140804 A1
(43) Pub. Date: Jun. 30, 2005

(54) Extended dynamic range image sensor capture using an array of fast and slow pixels

(75) Inventors: James E. Adams JR., Rochester, NY (US); John F. Hamilton JR., Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/747,593

(22) Filed: Dec. 29, 2003

(51) Int. Cl. H04N 5/202

(52) U.S. Cl. 348/254

(57) ABSTRACT

A method of extending the dynamic range of an imaging sensor including providing an image sensor having fast and slow pixels, wherein the fast pixels have a higher response to light exposure than the slow pixels; setting the dynamic range of the fast and slow pixels such that over an intermediate exposure range both fast and slow pixels produce an accurate representation of scene exposure but have different associated gains, while over a lower exposure range slow pixels produce a noise dominated signal, and over a higher exposure range fast pixels produce a saturated signal; and extending the dynamic range of the image sensor by adaptively adjusting higher exposure signals produced by fast pixels in response to higher exposure signals produced by slow pixels and by adaptively adjusting lower exposure signals produced by slow pixels in response to lower exposure signals produced by fast pixels.

### CROSS REFERENCE TO RELATED APPLICATION

Reference is made to commonly-assigned U.S. patent application Ser. No. 09/615/398 filed Jul. 13, 2000, entitled “Method and Apparatus to Extend the Effective Dynamic Range of an Image Sensing Device” by Gallagher et al, the disclosure of which is incorporated herein.

### FIELD OF THE INVENTION

The invention relates generally to the field of digital image processing, and in particular to a method of extending the effective dynamic range of an image sensing device.

### BACKGROUND OF THE INVENTION

The heart of the imaging capability of a digital camera is the image sensor. This sensor consists of an array of individual picture element sensors, or pixels. Regardless of electronics technology employed, e.g., CCD or CMOS, the pixel acts as a bucket in which photoelectrons are accumulated in direct proportion to amount of light that strikes the pixel. Photoelectrons are electrons that are created due to the interaction of light with the pixel. As such, they represent the signal being detected by the pixel. Thermal electrons are electrons that are created by the thermal conditions of the device and are generally not related to the light being sense by the pixel. However, thermal electrons will also be added to the pixel “bucket” and once included are indistinguishable from photoelectrons. Thermal electrons represent a major source of noise in the response of the pixel.

In most commercially available sensors today, the maximum ratio of signal to noise for a pixel is about 100:1. This, in turn, represents the maximum dynamic range of the pixel. Since the human visual system at any given moment is operating with an instantaneous dynamic range of about 100:1 there is a good match with the image capture capability of the sensor. However, scenes in nature often consist of visual information over a dynamic range that is much greater than 100:1. The human visual system is constantly adapting its instantaneous dynamic range to that most visually important information stays within its 100:1 dynamic range capability. However, a digital camera sensor has no such real-time adjustment capability. It is up to the camera's exposure adjustment system to properly regulate the amount of light falling on the sensor. If the exposure adjustment system makes an error and selects the wrong portion of the scene to capture within the dynamic range of the sensor, then the resulting image will be clipped, either in the shadows or the highlights.

Obviously, if the dynamic range of the pixel could be increased from 100:1, then more scene information could be recorded at capture time and subsequent image processing could properly create an image with the desired rendering. However, the current industry trends in sensor manufacturing are to make pixels smaller and sensors cheaper. The smaller the pixel, the fewer total photoelectrons it can accumulate. Since the number thermal electrons accumulated stays roughly the same as the pixel shrinks in size, the overall result is that smaller pixels have smaller dynamic ranges. Auxiliary photoelectron storage areas for each pixel on the sensor would increase the cost and complexity of the sensor. Still, the auxiliary storage area approach has its advocates. In commonly-assigned U.S. Patent Application No. U.S. 20030020100 (Guidash) provides a complete description of the problems with pixel-based auxiliary photoelectron storages areas.

What is needed is a method of increasing the dynamic range of an image sensor without fundamentally increasing the complexity or composition of the individual pixels in the sensor. Any proposed solution would also need to maintain the level of image quality of the final rendered image as compared to current standard sensor solutions.

### SUMMARY OF THE INVENTION

It is the object of the present invention to provide an effective way to extend the dynamic range of an imaging sensor of the type used, for example, in a digital camera.

It is another object to extend the dynamic range of the sensor without requiring substantial modifications of the individual pixel architectures while still maintaining the image quality produced by a standard sensor.

This object is achieved in a method of extending the dynamic range of an imaging sensor comprising:
(a) providing an image sensor having fast and slow pixels, wherein the fast pixels have a higher response to light exposure than the slow pixels;
(b) setting the dynamic range of the fast and slow pixels such that over an intermediate exposure range both fast and slow pixels produce an accurate representation of scene exposure but have different associated gains, while over a lower exposure range slow pixels produce a noise dominated signal, and over a higher exposure range fast pixels produce a saturated signal; and
(c) extending the dynamic range of the image sensor by adaptively adjusting higher exposure signals produced by fast pixels in response to higher exposure signals produced by slow pixels and by adaptively adjusting lower exposure signals produced by slow pixels in response to lower exposure signals produced by fast pixels.

It is an advantage of the present invention that only standard pixel architectures are required in the image sensor.

Other advantages include:

The image quality, especially with respect to spatial resolution, is preserved despite dividing the pixel population into two or more populations, each with its own dynamic range.

A variety of arrangements of pixels with differing dynamic ranges is supported while preserving image quality.

The newly produced single extended dynamic range image can be seamlessly inserted into a standard image processing chain for final rendering and use.

### BRIEF DESCRIPTION OF THE DRAWINGS

FIG. 1 is a perspective diagram of a computer system for implementing the present invention;

FIG. 2 is a diagram of a small region of an image sensor with a color filter array pattern superimposed;

FIG. 3 is a diagram of a small region of an image sensor showing a linear pattern of fast and slow pixels;

FIG. 4 is a diagram of a small region of an image sensor showing a checkerboard pattern of fast and slow pixels;

FIG. 5 is a diagram of the method used to reconstruct an extended dynamic range image;

FIG. 6 is a diagram of an interpolation neighborhood used to estimate a clipped fast green pixel value;

FIG. 7 is a diagram of an interpolation neighborhood used to estimate a clipped fast green pixel value;

FIG. 8 is a diagram of an interpolation neighborhood used to estimate a clipped fast red pixel value;

FIG. 9 is a diagram of an interpolation neighborhood used to estimate a clipped fast blue pixel value;

FIG. 10 is a diagram of an interpolation neighborhood used to estimate a clipped slow green pixel value;

FIG. 11 is a diagram of an interpolation neighborhood used to estimate a clipped slow green pixel value;

FIG. 12 is a diagram of an interpolation neighborhood used to estimate a clipped slow red pixel value;

FIG. 13 is a diagram of an interpolation neighborhood used to estimate a clipped slow blue pixel value;

FIG. 14 is a diagram of an interpolation neighborhood used to estimate a clipped fast green pixel value;

FIG. 15 is a diagram of an interpolation neighborhood used to estimate a clipped fast green pixel value;

FIG. 16 is a diagram of an interpolation neighborhood used to estimate a clipped fast red pixel value;

FIG. 17 is a diagram of an interpolation neighborhood used to estimate a clipped fast blue pixel value;

FIG. 18 is a diagram of an interpolation neighborhood used to estimate a clipped slow green pixel value;

FIG. 19 is a diagram of an interpolation neighborhood used to estimate a clipped slow green pixel value;

FIG. 20 is a diagram of an interpolation neighborhood used to estimate a clipped slow red pixel value; and

FIG. 21 is a diagram of an interpolation neighborhood used to estimate a clipped slow blue pixel value.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware and/or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such a personal computer. Consequently, the computer system will not be discussed in detail herein. It is also instructive to note that the images are either directly input into the computer system (for example by a digital camera) or digitized before input into the computer system (for example by scanning an original, such as a silver halide film).

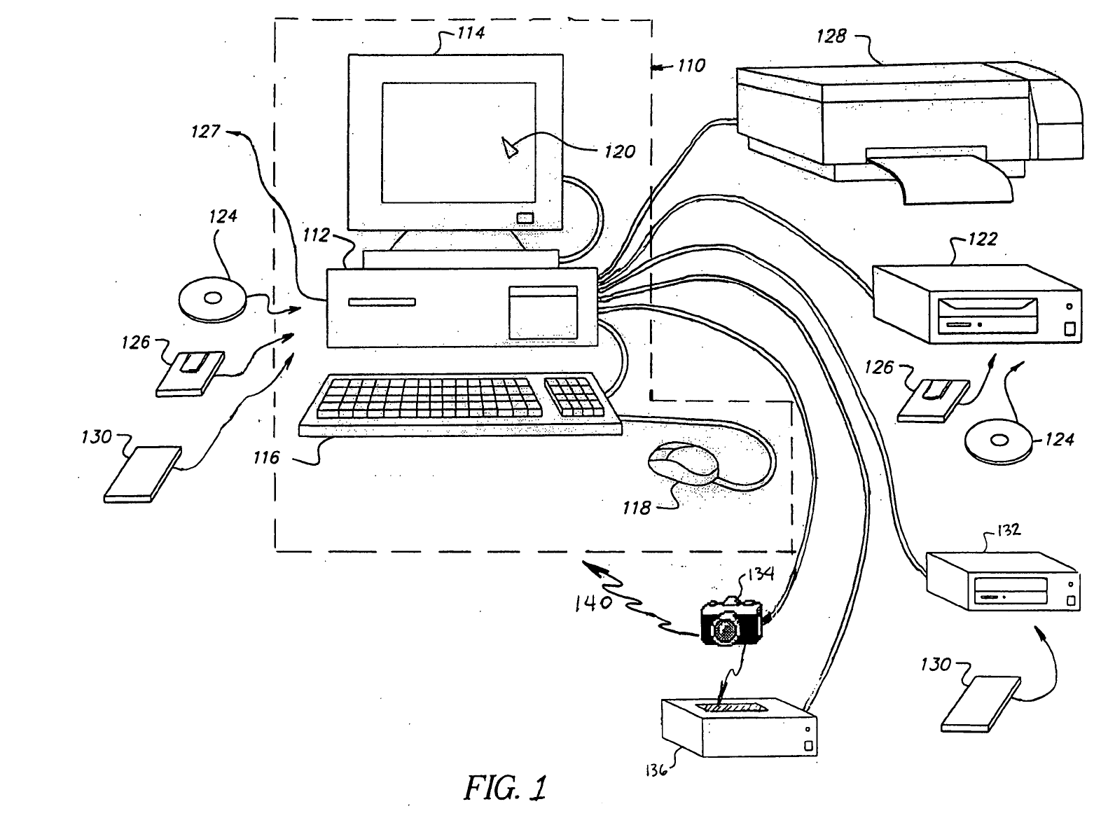

Referring to FIG. 1, there is illustrated a computer system 110 for implementing the present invention. Although the computer system 110 is shown for the purpose of illustrating a preferred embodiment, the present invention is not limited to the computer system 110 shown, but can be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 can be used for moving a selector 120 on the display 114 and for selecting an item on which the selector 120 overlays, as is well known in the art.

A compact disk-read only memory (CD-ROM) 124, which typically includes software programs, is inserted into the microprocessor based unit 112 for providing a means of inputting the software programs and other information to the microprocessor based unit 112. In addition, a floppy disk 126 can also include a software program, and is inserted into the microprocessor-based unit 112 for inputting the software program. The compact disk-read only memory (CD-ROM) 124 or the floppy disk 126 can alternatively be inserted into externally located disk drive unit 122 which is connected to the microprocessor-based unit 112. Still further, the microprocessor-based unit 112 can be programmed, as is well known in the art, for storing the software program internally. The microprocessor-based unit 112 can also have a network connection 127, such as a telephone line, to an external network, such as a local area network or the Internet. A printer 128 can also be connected to the microprocessor-based unit 112 for printing a hardcopy of the output from the computer system 110.

Images can also be displayed on the display 114 via a personal computer card (PC card) 130, such as, as it was formerly known, a PCMCIA card (based on the specifications of the Personal Computer Memory Card International Association) which contains digitized images electronically embodied in the card 130. The PC card 130 is ultimately inserted into the microprocessor based unit 112 for permitting visual display of the image on the display 114. Alternatively, the PC card 130 can be inserted into an externally located PC card reader 132 connected to the microprocessor-based unit 112. Images can also be input via the compact disk 124, the floppy disk 126, or the network connection 127. Any images stored in the PC card 130, the floppy disk 126 or the compact disk 124, or input through the network connection 127, can have been obtained from a variety of sources, such as a digital camera (not shown) or a scanner (not shown). Images can also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, the algorithm can be stored in any of the storage devices heretofore mentioned and applied to images in order to construct an extended dynamic range image.

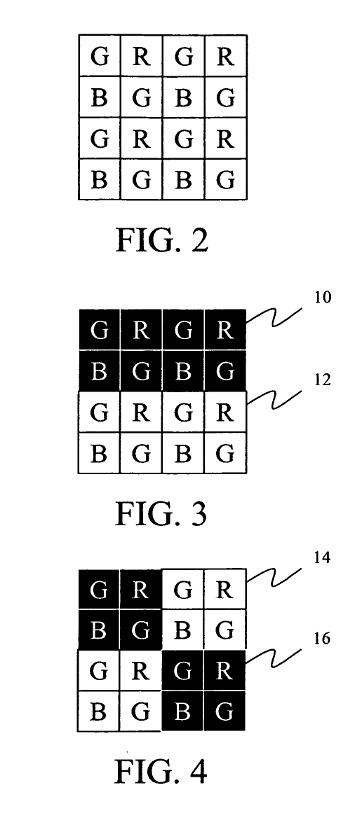

FIG. 2 presents a small region of an image sensor with a color filter array pattern superimposed. In this figure a pixel marked with an “R” is covered with a red filter, a pixel marked with a “G” is covered with a green filter, and a pixel marked with a “B” is covered with a blue filter. This figure represents the standard sensor situation in which each pixel has fundamentally the same photometric sensitivity, and, hence, dynamic range, modified only by the particular color filter array filter covering a given pixel.

FIG. 3 represents a small region of a modified image sensor in accordance with the preferred embodiment of this invention. Red, green, and blue filters are, once again, covering the individual pixels. However, the underlying pixels can have one of two possible photometric sensitivities. So-called “slow” pixels (block 10) have a relatively low photometric sensitivity and are largely responsive mostly to the brighter regions in the scene being imaged. For slow pixels, the darkest regions in the image will be clipped to zero, i.e., will not produce a significant, nonzero pixel value. “Fast” pixels (block 12) have a relatively high photometric sensitivity and are largely responsive mostly to the darker regions in the scene being imaged. For fast pixels, the brightest regions in the image will be clipped to the maximum allowable pixel value, e.g., 255 for an 8-bit capture system. Over the entirety of the sensor, the region in FIG. 3 would be tessellated to produce horizontal strips two pixels wide forming alternating pairs of rows of fast and slow pixels. It is understood that a similar pattern of fast and slow pixels could be oriented in the vertical direction, thus producing alternating pairs of columns of fast and slow pixels.

FIG. 4 represents a small region of a modified image sensor in accordance with a second embodiment of this invention. As with FIG. 3, red, green, and blue filters cover the individual pixels. Block 14 is a fast pixel and block 16 is a slow pixel. Over the entirety of the sensor, the region in FIG. 4 would be tessellated to produce a checkerboard pattern of two by two blocks of pixels alternating between fast blocks, containing a two by two array of fast pixels, and slow blocks, containing a two by two array of slow pixels.

In the preferred embodiment of this invention, the fast pixels of FIG. 3 and FIG. 4 would have twice the photometric sensitivity of the standard pixels of FIG. 2. The slow pixels of FIG. 3 and FIG. 4 would have half the photometric sensitivity of the standard pixels of FIG. 2. A second embodiment would be for the fast pixels to have four times the photometric sensitivity of standard pixels and slow pixels to have one-fourth the photometric sensitivity of standard pixels. Other embodiments of this nature are also practical.

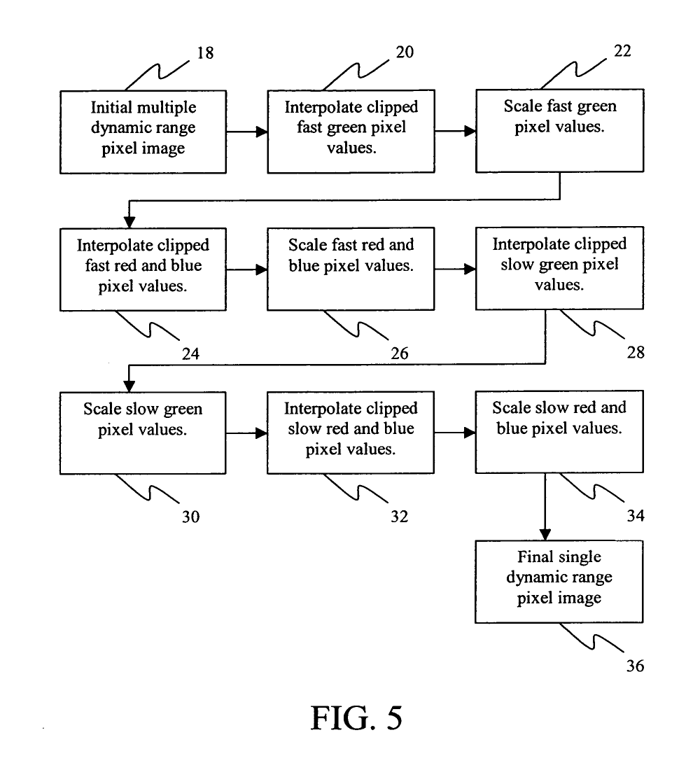

FIG. 5 is a block diagram of the image processing required to take an image captured with a FIG. 3 or FIG. 4 type of sensor and the produce and equivalent image that can have been captured with a FIG. 2 type of sensor if the FIG. 2 type of sensor had consisted of pixels with extended dynamic range capability. In terms of the preferred embodiment, the reconstructed image from FIG. 5 (block 36) will have valid (unclipped) pixel values that span four times the total dynamic range of the standard pixels depicted in FIG. 2. In the embodiment in which the fast pixels to have four times the photometric sensitivity of standard pixels and slow pixels to have one-fourth the photometric sensitivity of standard pixels, block 36 would have valid (unclipped) pixel values that span eight times the total dynamic range of the standard pixels depicted in FIG. 2.

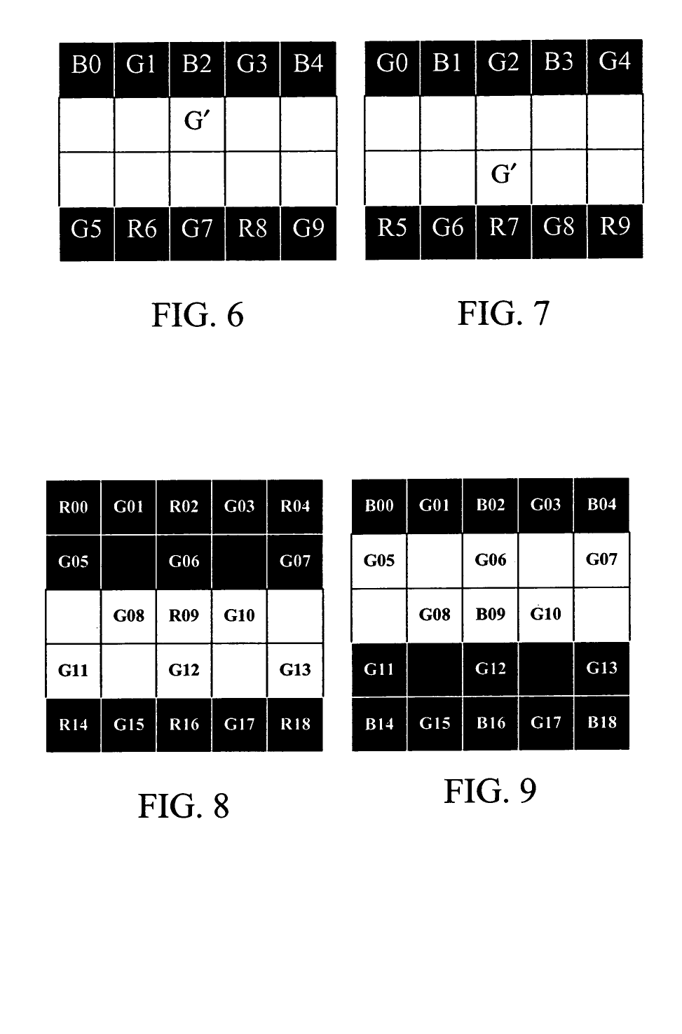

The process depicted in FIG. 5 begins with an image (block 18) captured with a sensor of either the type depicted in FIG. 3 or FIG. 4. The first image processing step (block 20) is to replaced the clipped fast green pixel values in the image with valid (unclipped) fast green pixel values. In order to do this, unclipped fast green pixel values are estimated by interpolating neighboring slow green pixel values. In the case of a FIG. 3 type of sensor, FIG. 6 and FIG. 7 represent the neighboring pixel values required for the conduct of block 20. In the case of FIG. 6, the task is to estimate an unclipped fast green pixel value at the location designated G′ using the neighboring slow pixel values. The first step is the compute the intermediate value G2′ with the following equation:

$${G2}^{′} = \frac{G1 + G3}{2} + \frac{3}{16} ( 2 B2 - B0 - B4 )$$

The next step is to compute three other intermediate values, called predictors, and designated v, b, and s:
v=(2G2′+G7)/3
b=(2G1+G9)/3
s=(2G3+G5)/3
The final step is to determine the maximum predictor value from v, b, and s. A scaled version of the maximum becomes the estimate for G′. As an equation this is equivalent to
G′=k max{v,b,s}
Since all of the neighboring pixel values used in the computation of G′ were slow pixels, k is used to scale the maximum to the equivalent fast pixel value. In the preferred embodiment, since slow pixels are one-quarter the photometric sensitivity of the fast pixels, k is equal to 4. In the alternate embodiment in which slow pixels are one-sixteenth the photometric sensitivity of the fast pixels, k is equal to 16. For the case of FIG. 7 the four intermediate values are

$$\begin{matrix}{G7}^{′} = \frac{G6 + G8}{2} + \frac{3}{16} ( 2 R7 - R5 - R9 ) \\ v = ( 2 {G7}^{′} + G2 ) / 3 \\ b = ( 2 G8 + G0 ) / 3 \\ s = ( 2 G6 + G4 ) / 3\end{matrix}$$

The resulting estimate for G′ is, once again, the scaled maximum predictor value:
G′=k max{v,b,s}

Once all of the clipped fast green pixel values in the image have been replaced with unclipped fast green pixel value estimates (block 20), then all of the fast green pixel values in the image are scaled to the photometric range representing the sensitivity of the standard sensor as depicted in FIG. 2 (block 22). In the preferred embodiment since the fast pixels have twice the photometric sensitivity of the standard pixels of FIG. 2, the scale factor, K, used in block 22 would be two. In the alternate embodiment in which the fast pixels have four times the photometric sensitivity of the standard pixels, K would be four. This process of block 22 can be expressed as the following equation:
G″=G′/K

After the fast green pixels in the image have been processed, the fast red and blue pixels in the image are processed. First, the clipped fast red and blue pixel values are replaced with valid (unclipped) pixel value estimates (block 24). In the case of a FIG. 3 type of sensor, FIG. 8 depicts the pixel neighborhood region used to replace a clipped fast red pixel value. Most of the labeled pixels in FIG. 8 are slow pixels. Five fast green pixels will also be used in the computation, so their equivalent slow pixel values are first computed. These equivalent slow pixel values are intermediate values and do not replace the actual pixel values in the image. The same scale value used in block 22, K, is used to convert the five fast green pixel values in FIG. 8. The equations would be:
G08*=G08/K
G10*=G10/K
G11*=G11/K
G12*=G12/K
G13*=G13/K
An intermediate value is now computed:
G09′=G06+G08*+G10*+G12*
This is followed by computing three high frequency directional components:
S_{Hi}=(G09′−(G11*+G15+G03+G07))/2
B_{Hi}=(G09′−(G01+G05+G13*+G17))/2
V_{Hi}=(G09′−(G01+G03+G15+G17))/2
Next, three predictors are computed:
S=(R04+R14+S_{Hi})/2
B=(R00+R18+B_{Hi})/2
V=(R02+R16+V_{Hi})/2
Finally, the scaled maximum predictor value becomes the unclipped estimate (R09′) for the clipped red fast pixel R09:
R09′=k max{S,B,V}

In the case of a FIG. 3 type of sensor, FIG. 9 represents the pixel neighborhood used to replace a clipped fast blue pixel value in block 24. The computation is similar to that just described for FIG. 8. Five fast green pixels are used in the computation, so their equivalent slow pixel values are first computed. These equivalent slow pixel values are intermediate values and do not replace the actual pixel values in the image. The same scale value used in block 22, K, is used to convert the five fast green pixel values in FIG. 9. The equations would be:
G05*=G05/K
G06*=G06/K
G07*=G07/K
G08*=G08/K
G10*=G10/K
An intermediate value is now computed:
G09′=G06*+G08*+G10*+G12
This is followed by computing three high frequency directional components:
S_{Hi}=(G09′−(G11+G15+G03+G07*))/2
B_{Hi}=(G09′−(G01+G05*+G13+G17))/2
V_{Hi}=(G09′−(G01+G03+G15+G17))/2
Next, three predictors are computed:
S=(B04+B14+S_{Hi})/2
B=(B00+B18+B_{Hi})/2
V=(B02+B16+V_{Hi})/2
Finally, the scaled maximum predictor value becomes the unclipped estimate (B09′) for the clipped blue fast pixel B09:
B09′=k max{S,B,V}

Once all of the clipped fast red and blue pixel values in the image have been replaced with unclipped fast red and blue pixel value estimates (block 24), then all of the fast red and blue pixel values in the image are scaled to the photometric range representing the sensitivity of the standard sensor as depicted in FIG. 2 (block 26). The identical operation in performed on the fast red and blue pixels in block 26 as is performed on the fast green pixels in block 22. As a result, the process of block 26 can be expressed as the following equations:
R″=R′/K
B″=B′/K

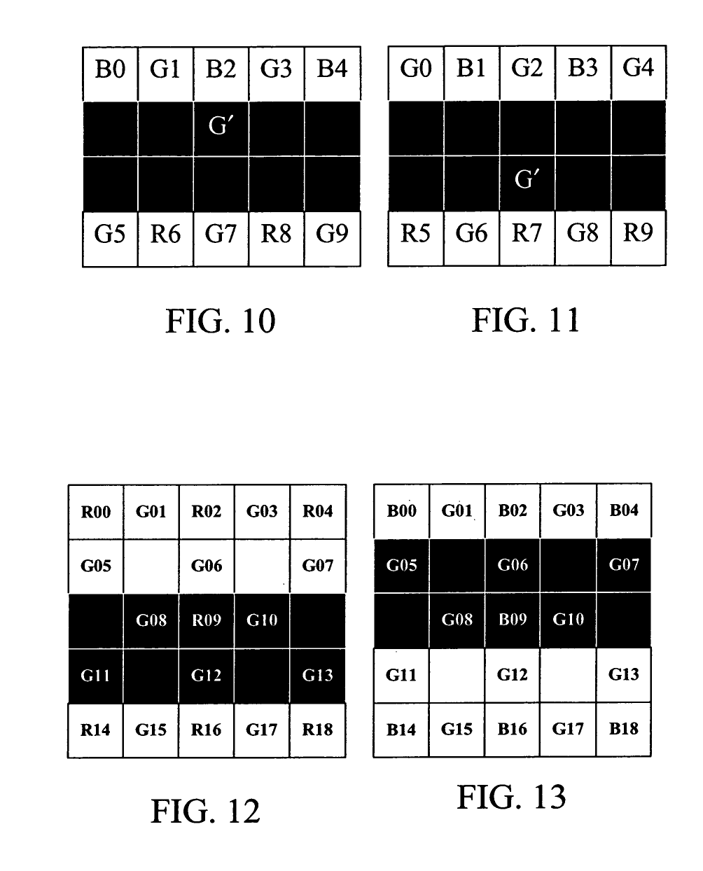

After all of the fast pixels have been processed, the processing of the slow pixels begins. The first slow pixel image processing step (block 28) replaces the clipped slow green pixel values in the image with valid (unclipped) slow green pixel values. In order to do this, unclipped slow green pixel values are estimated by interpolating neighboring fast green pixel values. In the case of a FIG. 3 type of sensor, FIG. 10 and FIG. 11 represent the neighboring pixel values required for the conduct of block 28. In the case of FIG. 10, the task is to estimate an unclipped slow green pixel value at the location designated G′ using the neighboring fast pixel values. The first step is the compute the intermediate value G2′ with the following equation:

$${G2}^{′} = \frac{G1 + G3}{2} + \frac{3}{16} ( 2 B2 - B0 - B4 )$$

The next step is to compute three other intermediate values, called predictors, and designated v, b, and s:
v=(2G2′+G7)/3
b=(2G1+G9)/3
s=(2G3+G5)/3

At this point it is noted that while in the case of clipped fast pixels any pixel value close to being clipped is probably still a valid and useful pixel value, the same cannot be necessarily said for clipped slow pixels. A slow pixel with a pixel value that is almost clipped can be composed of more noise than genuine signal variation. As a result, an almost clipped slow pixel value can not be very useful. Therefore the preferred embodiment treats slow pixels as being clipped if they have a small pixel value that is not necessarily equal to zero. Such a typical “soft-clip” value would be 20 for 12-bit image data. Block 28 would be executed for all soft-clipped as well as hard-clipped (pixel values of zero) slow pixels. The final step in block 28 is to determine the predictor value from v, b, and s that is closed to the scaled clipped slow pixel. If the clipped slow pixel is hard clipped, then this results in using the smallest predictor value. If the slow pixel is soft-clipped, then the slow pixel value is scaled by K, which is the same value as introduced in block 22, and then compared to the predictor values v, b, and s. The selected predictor value scaled by 1/K becomes the estimate for G′. If the clipped slow pixel value is c, then block 28 is equivalent to the following pseudocode

```
if ((|Kc−v| <= |Kc−b|) and (|Kc−v| <= |Kc−s|))
    then G′ = v/K
else if (|Kc−b| <= |Kc−s|)
    then G′ = b/K
else G′ = s/K
```

For the case of FIG. 11 the four intermediate values are

$$\begin{matrix}{G7}^{′} = \frac{G6 + G8}{2} + \frac{3}{16} ( 2 R7 - R5 - R9 ) \\ v = ( 2 {G7}^{′} + G2 ) / 3 \\ b = ( 2 G8 + G0 ) / 3 \\ s = ( 2 G6 + G4 ) / 3\end{matrix}$$

The resulting estimate for G′ is, once again, the predictor value closest to the scaled original clipped slow pixel value, divided by K.

Once all of the clipped slow green pixel values in the image have been replaced with unclipped slow green pixel value estimates (block 28), then all of the slow green pixel values in the image are scaled to the photometric range representing the sensitivity of the standard sensor as depicted in FIG. 2 (block 30). The scale factor is K, first introduced in block 22. This process of block 30 can be expressed as the following equation:
G″=KG′

After the slow green pixels in the image have been processed, the slow red and blue pixels in the image are processed. First, the clipped slow red and blue pixel values are replaced with valid (unclipped) pixel value estimates (block 32). In the case of a FIG. 3 type of sensor, FIG. 12 depicts the pixel neighborhood region used to replace a clipped slow red pixel value. We note that at this point in the computations that all green pixel values for both fast and slow pixels have been corrected to the same photometric scaling. To begin block 32 an intermediate value is computed:
G09′=G06+G08+G10+G12
This is followed by computing three high frequency directional components:
S_{Hi}=(G09′−(G11+G15+G03+G07))/2
B_{Hi}=(G09′−(G01+G05+G13+G17))/2
V_{Hi}=(G09′−(G01+G03+G15+G17))/2
Next, three predictors are computed:
S=(R04+R14+S_{Hi})/2
B=(R00+R18+B_{Hi})/2
V=(R02+R16+V_{Hi})/2

Finally, as in block 28, the predictor value closest to the scaled original clipped slow pixel value, divided by K, becomes the unclipped estimate, R09′, for the clipped red slow pixel R09:

```
if ((|K*R09−V|<=|K*R09−B|) and (|K*R09−V|<=|K*R09−S|))
    then R09′ = V/K
else if (|K*R09−B| <= |K*R09−S|)
    then R09′ = B/K
else R09′ = S/K
```

In the case of a FIG. 3 type of sensor, FIG. 13 represents the pixel neighborhood used to replace a clipped slow blue pixel value in block 32. The computation is similar to that just described for FIG. 12. An intermediate value is first computed:
G09′=G06+G08+G10+G12
This is followed by computing three high frequency directional components:
S_{Hi}=(G09′−(G11+G15+G03+G07))/2
B_{Hi}=(G09′−(G01+G05+G13+G17))/2
V_{Hi}=(G09′−(G01+G03+G15+G17))/2
Next, three predictors are computed:
S=(B04+B14+S_{Hi})/2
B=(B00+B18+B_{Hi})/2
V=(B02+B16+V_{Hi})/2
Finally, as with FIG. 12, the predictor value closest to the scaled original clipped slow pixel value, divided by K, becomes the unclipped estimate, B09′, for the clipped blue slow pixel B09.

Once all of the clipped slow red and blue pixel values in the image have been replaced with unclipped slow red and blue pixel value estimates (block 32), then all of the slow red and blue pixel values in the image are scaled to the photometric range representing the sensitivity of the standard sensor as depicted in FIG. 2 (block 34). The identical operation in performed on the slow red and blue pixels in block 34 as is performed on the slow green pixels in block 30. As a result, the process of block 34 can be expressed as the following equations:
R″=KR′
B″=KB′
The result (block 36) is an image with a single, nominal photometric scaling with valid data through an extended dynamic range. This image can now be treated as if it had been read directly from a sensor with extended dynamic range pixels. This completes the processing of image data from a FIG. 3 type sensor.

The processing of image data from a FIG. 4 type sensor follows the just described flow of processing image data from a FIG. 3 type sensor with adjustments made to accommodate the change in sensor geometry. The processing of image data from a FIG. 4 type sensor is now described.

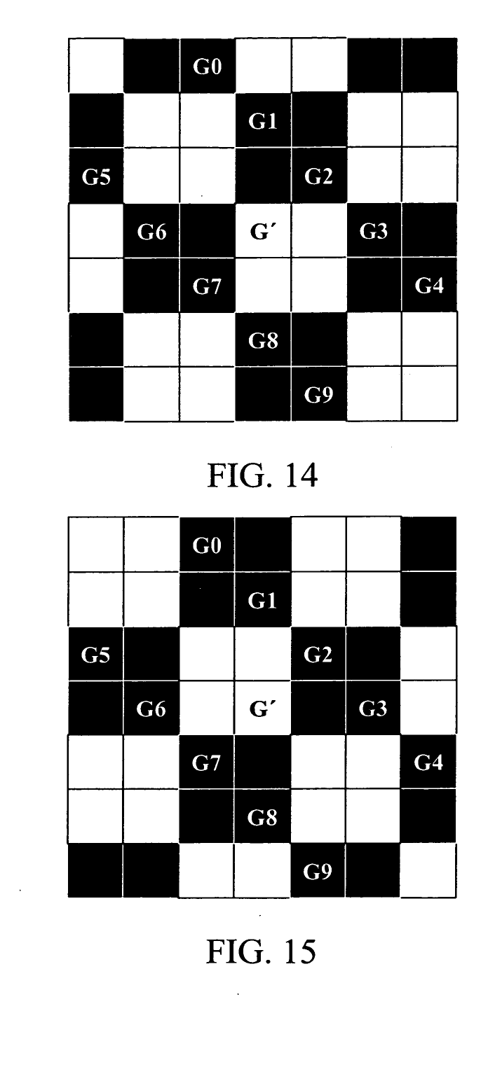

Returning to FIG. 5, the process begins with an image (block 18) captured with a sensor of the type depicted in FIG. 4. The first image processing step (block 20) is to replaced the clipped fast green pixel values in the image with valid (unclipped) fast green pixel values. In order to do this, unclipped fast green pixel values are estimated by interpolating neighboring slow green pixel values. In the case of a FIG. 4 type of sensor, FIG. 14 and FIG. 15 represent the neighboring pixel values required for the conduct of block 20. In the case of FIG. 14, the task is to estimate an unclipped fast green pixel value at the location designated G′ using the neighboring slow pixel values. The first step is the compute three intermediate values, called classifiers, with the following equations:
h=|G5−G2|+|G6−G3|+|G7−G4|
v=|G0−G7|+|G1−G8|+|G2−G9|
s=|G1−G6|+|G2−G7|+|G3−G8|
The next step is to compute three other intermediate values, called predictors:
H=(G6+G3)/2
V=(G1+G8)/2
S=(G2+G7)/2
At this point the method of the preferred embodiment could be used, namely, determine the maximum predictor value from H, V, and S. A scaled version of the maximum becomes the estimate for G′. As an equation this is equivalent to
G′=k max{H,V,S}
The value of k is the same one used in the preferred embodiment. A second embodiment is presented here for determining G′. Let G′c stand for the original clipped pixel value of G′. This value is scaled to an equivalent slow pixel value, g′c:
g′c=G′c/k
Any value of H, V, or S that is less than g′c is disqualified as a possible estimate for G′. Of the remaining predictor values, the smallest one multiplied by k is selected as the estimate for G′. If all of the predictors are less than g′c, then G′ is set equal to k(g′c−1).

For the case of FIG. 15 once the appropriate pixel values have been assigned to G0 through G9, the computations are identical to those used in conjunction with FIG. 14.

Once all of the clipped fast green pixel values in the image have been replaced with unclipped fast green pixel value estimates (block 20), then all of the fast green pixel values in the image are scaled to the photometric range representing the sensitivity of the standard sensor as depicted in FIG. 2 (block 22). The method used is the same as in the preferred embodiment.

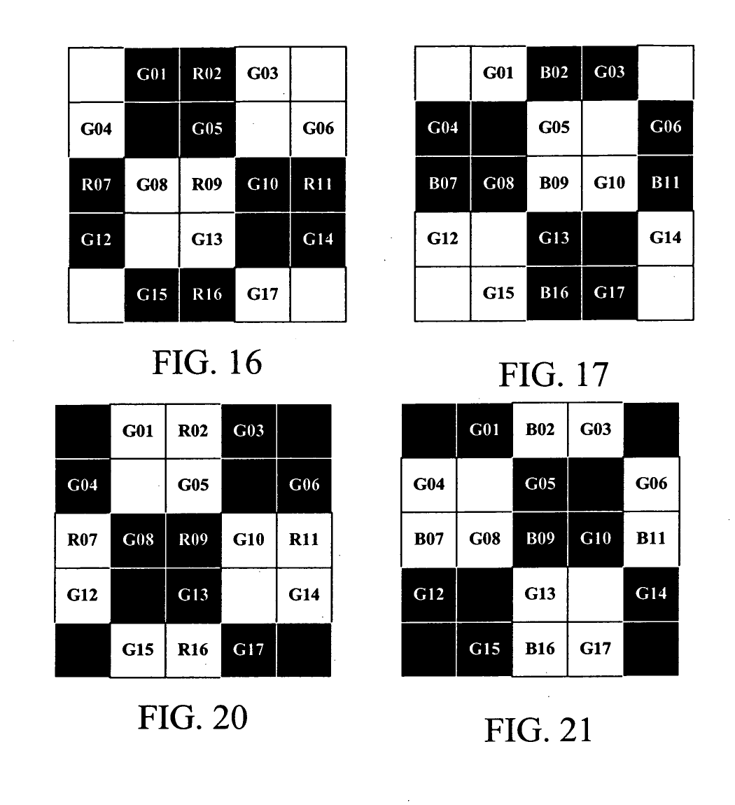

After the fast green pixels in the image have been processed, the fast red and blue pixels in the image are processed. First, the clipped fast red and blue pixel values are replaced with valid (unclipped) pixel value estimates (block 24). In the case of a FIG. 4 type of sensor, FIG. 16 depicts the pixel neighborhood region used to replace a clipped fast red pixel value. Most of the labeled pixels in FIG. 16 are slow pixels. Six fast green pixels will also be used in the computation, so their equivalent slow pixel values are first computed. These equivalent slow pixel values are intermediate values and do not replace the actual pixel values in the image. The same scale value used in block 22, K, is used to convert the five fast green pixel values in FIG. 8. The equations would be:
G03*=G03/K
G04*=G04/K
G06*=G06/K
G08*=G08/K
G13*=G13/K
G17*=G17/K
Two classifiers, h and v, are now computed:
h₁=2G05−G04*−G06*
h₂=2G13*−G12−G14
h=|h₁|+|h₂|
v₁=2G08*−G01−G15
v₂=2G10−G03*−G17*
v=|v₁|+|v₂|
This is followed by computing two predictors:
H=(R07+R11+(h₁+h₂)/2)/2
V=(R02+R16+(v₁+v₂)/2)/2
In the preferred embodiment, the scaled maximum predictor value becomes the unclipped estimate (R09′) for the clipped red fast pixel R09:
R09′=k max{H,V}
A second embodiment is presented here for determining R09′. Let R09c stand for the original clipped pixel value of R09. This value is scaled to an equivalent slow pixel value, r09c:
r09c=R09c/k
If either value of H or V is less than r09c, it is disqualified as a possible estimate for R09′. Of the remaining predictor values, the one with the smallest associated predictor, i.e., h for H and v for V, multiplied by k is selected as the estimate for R09′. If all of the predictors are less than r09c, then R09′ is set equal to k(r09c−1).

In the case of a FIG. 4 type of sensor, FIG. 17 represents the pixel neighborhood used to replace a clipped fast blue pixel value in block 24. The computation is similar to that just described for FIG. 16. Six fast green pixels are used in the computation, so their equivalent slow pixel values are first computed. These equivalent slow pixel values are intermediate values and do not replace the actual pixel values in the image. The same scale value used in block 22, K, is used to convert the six fast green pixel values in FIG. 17. The equations would be:
G01*=G01/K
G05*=G05/K
G10*=G10/K
G12*=G12/K
G14*=G14/K
G15*=G15/K
Two classifiers, h and v, are now computed:
h₁=2G05*−G04−G06
h₂=2G13−G12*−G14*
h=|h₁|+|h₂|
v₁=2G08−G01*G15*
v₂=2G10*−G03−G17
v=|v₁|+|v₂|
This is followed by computing two predictors:
H=(B07+B11+(h₁+h₂)/2)/2
V=(B02+B16+(v₁+v₂)/2)/2
In the preferred embodiment, the scaled maximum predictor value becomes the unclipped estimate (B09′) for the clipped blue fast pixel B09:
B09′=k max{H,V}
A second embodiment is presented here for determining B09′. Let B09c stand for the original clipped pixel value of B09. This value is scaled to an equivalent slow pixel value, b09c:
b09c=B09c/k
If either value of H or V is less than b09c, it is disqualified as a possible estimate for B09′. Of the remaining predictor values, the one with the smallest associated predictor, i.e., h for H and v for V, multiplied by k is selected as the estimate for B09′. If all of the predictors are less than b09c, then B09′ is set equal to k(b09c−1).

Once all of the clipped fast red and blue pixel values in the image have been replaced with unclipped fast red and blue pixel value estimates (block 24), then all of the fast red and blue pixel values in the image are scaled to the photometric range representing the sensitivity of the standard sensor as depicted in FIG. 2 (block 26). The identical operation in performed on the fast red and blue pixels in block 26 as is performed on the fast green pixels in block 22. As a result, the process of block 26 can be expressed as the following equations:
R″=R′/K
B″=B′/K

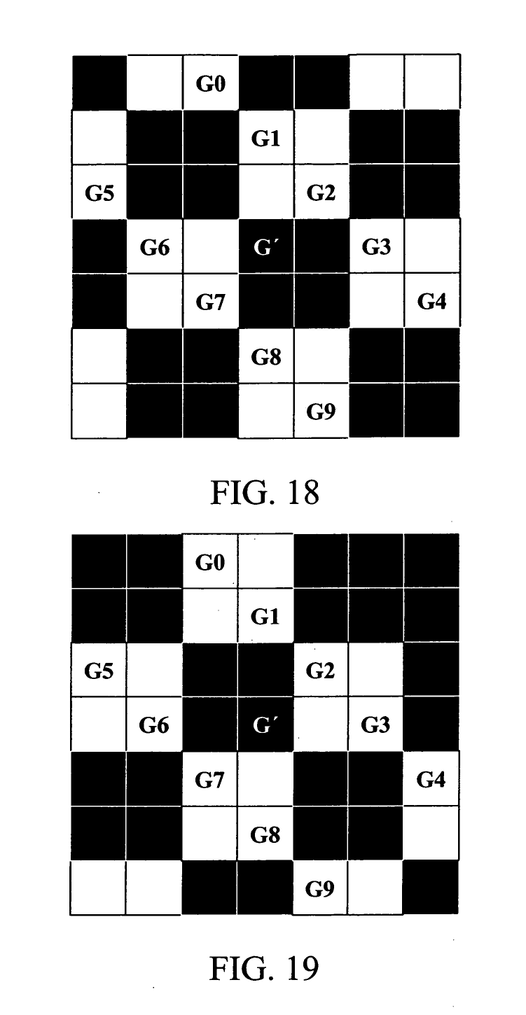

After all of the fast pixels have been processed, the processing of the slow pixels begins. The first slow pixel image processing step (block 28) replaces the clipped slow green pixel values in the image with valid (unclipped) slow green pixel values. In order to do this, unclipped slow green pixel values are estimated by interpolating neighboring fast green pixel values. In the case of a FIG. 4 type of sensor, FIG. 18 and FIG. 19 represent the neighboring pixel values required for the conduct of block 28. In the case of FIG. 18, the task is to estimate an unclipped slow green pixel value at the location designated G′ using the neighboring fast pixel values. The first step is the compute three intermediate values, called classifiers, with the following equations:
h=|G5−G2|+|G6−G3|+|G7−G4|
v=|G0−G7|+|G1−G8|+|G2−G9|
s=|G1−G6|+|G2−G7|+|G3−G8|
The next step is to compute three other intermediate values, called predictors:
H=(G6+G3)/2
V=(G1+G8)/2
S=(G2+G7)/2

At this point it is noted that while in the case of clipped fast pixels any pixel value close to being clipped is probably still a valid and useful pixel value, the same cannot be necessarily said for clipped slow pixels. A slow pixel with a pixel value that is almost clipped can be composed of more noise than genuine signal variation. As a result, an almost clipped slow pixel value can not be very useful. Therefore the preferred embodiment treats slow pixels as being clipped if they have a small pixel value that is not necessarily equal to zero. Such a typical “soft-clip” value would be 20 for 12-bit image data. Block 28 would be executed for all soft-clipped as well as hard-clipped (pixel values of zero) slow pixels. The final step in block 28 is to determine the predictor value from v, b, and s that is closed to the scaled clipped slow pixel. If the clipped slow pixel is hard clipped, then this results in using the smallest predictor value. If the slow pixel is soft-clipped, then the slow pixel value is scaled by K, which is the same value as introduced in block 22, and then compared to the predictor values v, b, and s. The selected predictor value scaled by 1/K becomes the estimate for G′. If the clipped slow pixel value is c, then block 28 is equivalent to the following pseudocode:

```
if ((|Kc−v| <= |Kc−b|) and (|Kc−v| <= |Kc−s|))
    then G′ = v/K
else if (|Kc−b| <= |Kc−s|)
    then G′ = b/K
else G′ = s/K
```

At this point the method of the preferred embodiment could be used, namely, determine the maximum predictor value from H, V, and S. A scaled version of the maximum becomes the estimate for G′. As an equation this is equivalent to
G′=k max{H,V,S}
The value of k is the same one used in the preferred embodiment. A second embodiment is presented here for determining G′. Let G′c stand for the original clipped pixel value of G′. This value is scaled to an equivalent slow pixel value, g′c:
g′c=G′c/k
Any value of H, V, or S that is less than g′c is disqualified as a possible estimate for G′. Of the remaining predictor values, the smallest one multiplied by k is selected as the estimate for G′. If all of the predictors are less than g′c, then G′ is set equal to k(g′c−1).

For the case of FIG. 19 once the appropriate pixel values have been assigned to G0 through G9, the computations are identical to those used in conjunction with FIG. 18.

Once all of the clipped slow green pixel values in the image have been replaced with unclipped slow green pixel value estimates (block 28), then all of the slow green pixel values in the image are scaled to the photometric range representing the sensitivity of the standard sensor as depicted in FIG. 2 (block 30). The scale factor is K, first introduced in block 22. This process of block 30 can be expressed as the following equation:
G″=KG′

After the slow green pixels in the image have been processed, the slow red and blue pixels in the image are processed. First, the clipped slow red and blue pixel values are replaced with valid (unclipped) pixel value estimates (block 32). In the case of a FIG. 4 type of sensor, FIG. 20 depicts the pixel neighborhood region used to replace a clipped slow red pixel value. We note that as this point in the computations that all green pixel values have been corrected to the same photometric scaling. The first step in block 32 to compute two classifiers, h and v:
h₁=2G05−G04−G06
h₂=2G13−G12−G14
h=|h₁|+|h₂|
v₁=2G08−G01−G15
v₂=2G10−G03−G17
v=|v₁|+|v₂|
This is followed by computing two predictors:
H=(R07+R11+(h₁+h₂)/2)/2
V=(R02+R16+(v₁+v₂)/2)/2
Finally, let R09c stand for the original clipped pixel value of R09. This value is scaled to an equivalent fast pixel value, r09c:
r09c=R09c*K
Of the predictor values, H and V, the one with the smallest associated predictor, i.e., h for H and v for V, divided by K is selected as the estimate for R09′.

In the case of a FIG. 4 type of sensor, FIG. 21 depicts the pixel neighborhood region used to replace a clipped slow blue pixel value. We note that as this point in the computations that all green pixel values have been corrected to the same photometric scaling. The first step in block 32 to compute two classifiers, h and v:
h₁=2G05−G04−G06
h₂=2G13−G12−G14
h=|h₁|+|h₂|
v₁=2G08−G01−G15
v₂=2G10−G03−G17
v=|v₁|+|v₂|
This is followed by computing two predictors:
H=(B07+B11+(h₁+h₂)/2)/2
V=(B02+B16+(v₁+v₂)/2)/2
Finally, let B09c stand for the original clipped pixel value of B09. This value is scaled to an equivalent fast pixel value, b09c:
b09c=B09c*K
Of the predictor values, H and V, the one with the smallest associated predictor, i.e., h for H and v for V, divided by K is selected as the estimate for B09′.

Once all of the clipped slow red and blue pixel values in the image have been replaced with unclipped slow red and blue pixel value estimates (block 32), then all of the slow red and blue pixel values in the image are scaled to the photometric range representing the sensitivity of the standard sensor as depicted in FIG. 2 (block 34). The identical operation in performed on the slow red and blue pixels in block 34 as is performed on the slow green pixels in block 30. As a result, the process of block 34 can be expressed as the following equations:
R″=KR′
B″=KB′
The result (block 36) is an image with a single, nominal photometric scaling with valid data through an extended dynamic range. This image can now be treated as if it had been read directly from a sensor with extended dynamic range pixels. This completes the processing of image data from a FIG. 4 type sensor.

The specific algorithms disclosed in the preferred embodiments of the present invention can be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that can be used as a processing unit, a display unit, or a unit to give processing instructions), and as a service offered via the World Wide Web.

In each case, the algorithm to produce extended dynamic range images can stand alone or can be a component of a larger system solution. Furthermore, the interfaces with the algorithm, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the algorithm(s) themselves can be fully automatic, can have user input (be fully or partially manual), can have user or operator review to accept/reject the result, or can be assisted by metadata (metadata that can be user supplied, supplied by a measuring device (e.g. in a camera), or determined by an algorithm). Moreover, the algorithm(s) can interface with a variety of workflow user interface schemes.

The algorithms to produce extended dynamic range images disclosed herein in accordance with the invention can have interior components that utilize various data detection and reduction techniques (e.g., face detection, eye detection, skin detection, flash detection) The invention has been described in detail with particular reference to certain preferred embodiments thereof, but it will be understood that variations and modifications can be effected within the spirit and scope of the invention.

### Parts List

10 Slow Pixel
12 Fast Pixel
14 Fast Pixel
16 Slow Pixel
18 Multiple Dynamic Range Image
20 Fast Clipped Green Pixel Interpolation Block
22 Fast Green Pixel Scaling Block
24 Fast Clipped Red and Blue Pixel Interpolation Block
26 Fast Red and Blue Pixel Scaling Block
28 Slow Clipped Green Pixel Interpolation Block
30 Slow Green Pixel Scaling Block
32 Slow Clipped Red and Blue Pixel Interpolation Block
34 Slow Red and Blue Pixel Scaling Block
36 Extended Dynamic Range Image
110 Computer System
112 Microprocessor-based Unit
114 Display
116 Keyboard
118 Mouse
120 Selector on Display
122 Disk Drive Unit
124 Compact Disk-read Only Memory (CD-ROM)
126 Floppy Disk
127 Network Connection
128 Printer
130 Personal Computer Card (PC card)
132 PC Card Reader
134 Digital Camera
   Parts List Cont'd
136 Camera Docking Port
138 Cable Connection
140 Wireless Connection

1. A method of extending the dynamic range of an imaging sensor comprising:
(a) providing an image sensor having fast and slow pixels, wherein the fast pixels have a higher response to light exposure than the slow pixels;
(b) setting the dynamic range of the fast and slow pixels such that over an intermediate exposure range both fast and slow pixels produce an accurate representation of scene exposure but have different associated gains, while over a lower exposure range slow pixels produce a noise dominated signal, and over a higher exposure range fast pixels produce a saturated signal; and
(c) extending the dynamic range of the image sensor by adaptively adjusting higher exposure signals produced by fast pixels in response to higher exposure signals produced by slow pixels and by adaptively adjusting lower exposure signals produced by slow pixels in response to lower exposure signals produced by fast pixels.

2. A method of extending the dynamic range of an imaging sensor comprising:
(a) providing an image sensor having pixels in alternating pairs of rows wherein one pair has fast pixels and the adjacent pair has slow pixels, such that the fast pixels have a higher response to light exposure than the slow pixels;
(b) setting the dynamic range of the pixels in the alternating fast and slow pairs of rows such that over an intermediate exposure range both fast and slow pixels produce an accurate representation of scene exposure but have different associated gains, while over a lower exposure range slow pixels produce a noise dominated signal, and over a higher exposure range fast pixels produce a saturated signal; and
(c) extending the dynamic range of the image sensor by adaptively adjusting higher exposure signals produced by fast pixels in response to higher exposure signals produced by slow pixels and by adaptively adjusting lower exposure signals produced by slow pixels in response to lower exposure signals produced by fast pixels.

3. The method of claim 2 wherein the adjustment of the higher exposure signal produced by a fast pixel includes computing at least two corrected signals based on neighboring slow pixels and selecting one of these corrected signals based on the largest of the corrected signals.

4. The method of claim 2 wherein the adjustment of the lower exposure signal produced by a slow pixel includes computing at least two corrected signals based on neighboring fast pixels and selecting one of these corrected signals based on the lowest of the corrected signals.

5. A method of extending the dynamic range of an imaging sensor comprising:
(a) providing an image sensor having fast and slow blocks of pixels wherein the fast blocks contain a two by two array of fast pixels and the slow blocks contain a two by two array of slow pixels such that the fast pixels have a higher response to light exposure than the slow pixels and such that the fast and slow blocks of pixels are arranged in a checkerboard pattern;
(b) setting the dynamic range of the pixels in the fast and slow blocks such that over an intermediate exposure range both fast and slow pixels produce an accurate representation of scene exposure but have different associated gains, while over a lower exposure range slow pixels produce a noise dominated signal, and over a higher exposure range fast pixels produce a saturated signal; and
(c) extending the dynamic range of the image sensor by adaptively adjusting higher exposure signals produced by fast pixels in response to higher exposure signals produced by slow pixels and by adaptively adjusting lower exposure signals produced by slow pixels in response to lower exposure signals produced by fast pixels.

6. The method of claim 5 wherein the adjustment of the higher exposure signal produced by a fast pixel includes computing at least two corrected signals based on neighboring slow pixels and selecting one of these corrected signals or the original higher exposure signal produced by the fast pixel.

7. The method of claim 5 wherein the adjustment of the lower exposure signal produced by the slow pixel includes computing at least two corrected signals based on neighboring fast pixels and selecting one of these corrected signals based on the corrected signal closest to the original noise dominated signal of the slow pixel.

8. A method of extending the dynamic range of an imaging sensor comprising:
(a) providing an image sensor having pixels in alternating pairs of columns wherein one pair has fast pixels and the adjacent pair has slow pixels, such that the fast pixels have a higher response to light exposure than the slow pixels;
(b) setting the dynamic range of the pixels in the alternating fast and slow pairs of columns such that over an intermediate exposure range both fast and slow pixels produce an accurate representation of scene exposure but having different associated gains, while over a lower exposure range slow pixels produce a noise dominated signal, and over a higher exposure range fast pixels produce a saturated signal; and
(c) extending the dynamic range of the image sensor by adaptively adjusting higher exposure signals produced by fast pixels in response to higher exposure signals produced by slow pixels and by adaptively adjusting lower exposure signals produced by slow pixels in response to lower exposure signals produced by fast pixels.
